(19) United States
(12) Patent Application Publication
(10) Pub. No.: US 2025/0086711 A1
(43) Pub. Date: Mar. 13, 2025

(54) System and Method for Linking Cryptocurrency to a Physical Asset

(71) Applicant: Ritchy Leandro Marques, Mulmur (CA)

(72) Inventor: Ritchy Leandro Marques, Mulmur (CA)

(21) Appl. No.: 18/462,542

(22) Filed: Sep. 7, 2023

(51) Int. Cl. G06Q 40/04; G06Q 20/38

(52) U.S. Cl. CPC G06Q 40/04; G06Q 20/389

(57) ABSTRACT

A system and method for linking cryptocurrency to a physical asset is provided. The system and method for linking cryptocurrency to a physical asset provides for the issuance, trading, and redemption of cryptocurrency tokens backed by physical assets. The system includes a specialized trading network of interconnected computers, facilitated through a trading protocol and a decentralized ledger. Participants engage in secure transactions with transfer, redemption, and burn functions to maintain parity of the tokens and physical assets. The system provides a secure, efficient, and transparent means for token holders to trade and redeem backed assets within a decentralized framework.

### BACKGROUND OF THE INVENTION

The present invention relates to a system and method for linking cryptocurrency to a physical asset. The present invention further provides a system and method that combines blockchain technology with physical assets such that the cryptocurrency token or coin quantity and a minimum value is backed by a physical asset or reserve.

Blockchain and cryptocurrency has transformed the financial landscape by offering decentralized ledger technology that facilitates transactions and investment opportunities. A blockchain is the underlying technology that enables the existence and operation of cryptocurrencies and has various other applications beyond cryptocurrencies. A blockchain is implemented by software that is executed by a series of computers, sometimes referred to as a node, which is participating in the particular overall system that the data stored in the blockchain is being used, e.g., to track payments of digital currency. Generally, the software running on each node maintains a copy/replica of the blockchain. The combination of the blockchain and the software which maintains it may collectively be referred to simply as a blockchain. The data stored in a blockchain is typically collected or grouped together, such as on a quantitative and/or periodic basis, into blocks where each block is coupled or linked, such as in a cryptographic manner, with a prior block forming a chain of blocks which may continue to grow as new data is added. Each of the replicated blockchains communicates with the others via a network, such as the Internet. Using the replicated ledgers of blockchain along with cryptographically linking/chaining, the transactions stored therein enable all users to ensure the reliability of the transaction data.

Traditional cryptocurrencies have gained significant popularity due to their decentralized nature and the ability to facilitate peer-to-peer transactions efficiently. However, cryptocurrency value is generally understood as being derived from a combination of factors related to its scarcity, utility, network effect, and market demand which has led to concerns about stability and security. The absence of backing by tangible assets raises questions about their underlying value and susceptibility to market fluctuations. In contrast, physical assets like precious metals have stood the test of time as reliable stores of value. For centuries, gold, silver, diamonds, and other tangible resources have provided stability in uncertain economic environments. These assets possess intrinsic worth and a historical record of retaining value over extended periods. However, their transferability and liquidity are limited, often requiring complex processes for trade and storage. Investors seeking to combine the benefits of cryptocurrency's efficiency and the stability of tangible assets face challenges.

Investors seeking to diversify their portfolios and hedge against economic uncertainties have explored alternative investment options such as purchasing physical assets like gold and silver. Precious metals have a long-standing history as stores of value, offering stability and serving as a hedge against inflation. Traditionally, investors have turned to exchange-traded funds (ETFs) as a means to gain exposure to gold and silver markets. However, ETFs suffer from limitations, including the inability for investors to directly redeem physical assets, which undermines the fundamental principle of asset ownership. Currently, there exists no suitable solution that effectively addresses these problems. There are other risks associated with some investments in cryptocurrencies. For example, traditional inventors may avoid certain cryptocurrencies as these cryptocurrencies are unregulated which has led to fraudulent schemes and Ponzi schemes.

Given these considerations, there is a need for an innovative solution that marries the dynamic features of cryptocurrencies with the ability to hedge against inflation through ownership of physical assets. By bridging the gap between digital and tangible assets, this system offers investors a secure, efficient, and tradable representation of physical value within the cryptocurrency realm.

In light of the devices disclosed in the known art, it is submitted that the present invention substantially diverges in design elements and methods from the known art and consequently it is clear that there is a need in the art for an improvement for system and method for linking cryptocurrency to a physical asset. In this regard the instant invention substantially fulfills these needs.

### SUMMARY OF THE INVENTION

In view of the foregoing disadvantages inherent in the known types of cryptocurrency systems and methods now present in the known art, the present invention provides a new system and method for linking cryptocurrency to a physical asset.

It is an objective of the present invention to provide a system and method for linking cryptocurrency to a physical asset comprising: a cryptocurrency token linked with a physical asset, allowing token holders to access and exchange tangible resources through a blockchain-based mechanism that provides update a real-time physical asset reserve amount on the blockchain, representing the total quantity of physical assets backing the cryptocurrency tokens, ensuring transparency and accuracy. Furthermore, it establishes a specialized trading network consisting of a decentralized blockchain ledger and a plurality of computers, facilitating secure and efficient trading, exchange, and redemption of the cryptocurrency tokens and physical assets.

It is an objective of the present invention to implement a trading protocol within the specialized trading network that enables seamless communication, exchange, and redemption of cryptocurrency tokens, while maintaining a continuous calculation of physical asset per cryptocurrency token or coin minimum value based on the real-time physical asset reserve amount.

It is an objective of the present invention to receive transaction requests within the specialized trading network, facilitating the transfer of cryptocurrency tokens from a sender to a recipient.

It is another objective of the present invention to deploy a trading protocol that utilizes smart contracts to execute cryptocurrency token to physical asset exchanges, ensuring automated and secure transactions. Additionally, the smart contract ensures physical delivery of the physical asset upon redemption.

It is an objective of the present invention to record and validate cryptocurrency token transfers by broadcasting transaction requests across the specialized trading network for consensus, ensuring the accuracy and security of transactions.

It is an objective of the present invention to implement a burn mechanism associated with redemption requests, reducing the total number of tokens in circulation, and maintaining the accurate correlation between tokens and physical assets. This burn process is recorded on the blockchain for transparent tracking and auditing.

It is an objective of the present invention to provide an investment vehicle within cryptocurrency to hedge against inflation.

It is therefore an object of the present invention to provide a new and improved system and method for linking cryptocurrency to a physical asset that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram an embodiment of the system for administering a specialized trading network of a physical asset via a cryptocurrency on a blockchain.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be as a system and method for linking cryptocurrency to a physical asset, such as silver using Binance BSC, Cardano, Ethereum, or any other blockchain. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

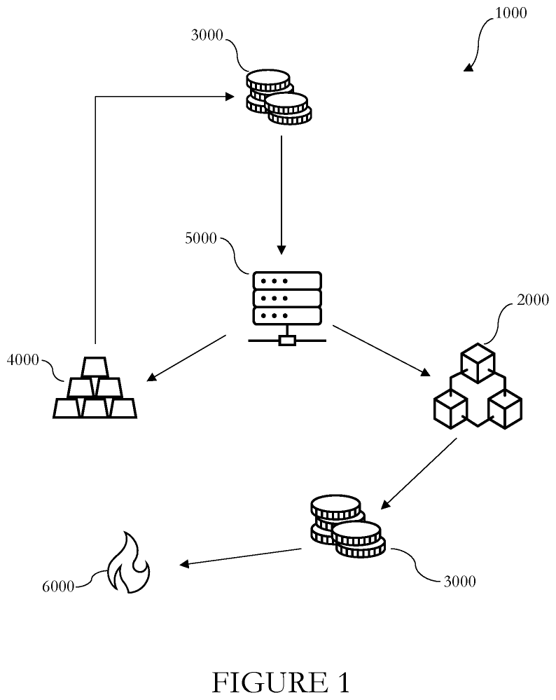

Referring now to FIG. 1, there is shown a diagram of an embodiment of the system for administering a specialized trading network of a physical asset via a cryptocurrency on a blockchain. The system 1000 provides for the issuance, trading, and redemption of cryptocurrency tokens backed by physical assets 4000. The system 1000 comprises a specialized trading network 5000 of interconnected computers, facilitated through a trading protocol and a decentralized ledger. As used herein, “network” is intended to encompass any network capable of transmitting information from one entity to another. The specialized trading network may be as few as several personal computers on a Local Area Network (LAN) or as large as the Internet, a worldwide network of computers. The cryptocurrency 3000 includes distributed ledgers/crypto ledgers (such as blockchains) to document and verify ownership and availability of the cryptographic tokens (referred to herein as “tokens”). The tokens 3000 are associated with various digital accounts referred to as addressed accounts or wallets. The distributed ledger records changes of ownership of the tokens from one digital account (sender) to another digital account (receiver). The trading protocol serves as a set of rules and procedures governing how participants interact within the network.

In one embodiment, the physical assets 4000, such as gold, silver, diamonds, and other precious metals and/or commodities, is stored within a secured location. In some embodiments, a custodial agreement is reached with an entity that specializes in the security of the physical asset. From the initial supply of physical asset, a token or coin is issued that corresponds to the initial supply of the physical asset, thereby establishing a link between the value and quantity of physical assets to the quantity and minimum or base value of the tokens. As used herein, “token” and “coin” are used interchangeably. Each token in the total supply represents a specific amount of physical assets also known as asset per token amount. In this way, tokens are created or issued in accordance with the acquisition of the physical asset. The tokens in circulating supply have an asset per token amount that increased or decreases with the supply increasing or decreasing in relation to the total physical assets being held in the asset reserve backing the circulating supply of coins and or tokens.

Another feature of the system is the ability to trade and redeem the tokens. In one embodiment, the system incorporates a smart contract to automate the purchase and redemption process. These contracts ensure secure and transparent transactions by facilitating the transfer of tokens (the asset per token equivalent) in exchange for the purchasing asset. Further, token holders can exchange their tokens for the corresponding asset and have it delivered to them, effectively removing the token from circulation through a burn mechanism.

In one embodiment, the system features a real-time update of the physical asset reserve amount, ensuring accurate representation. The trading protocol maintains a calculation of the physical asset per cryptocurrency token based on the physical asset reserve amount.

In one embodiment, the specialized trading network comprises a memory communicatively coupled to a processor, wherein the memory stores computer readable instructions that when executed by the processor causes the processor to: receive a transaction request for a transfer of the cryptocurrency token from a sender to a recipient, wherein the transaction request includes the recipient's address and an amount of cryptocurrency tokens to be transferred. In one embodiment, the “memory” comprises non-transitory computer-readable storage medium.

In one embodiment, the processor is configured to record and validate the transfer by broadcasting the transaction request to the specialized trading network for consensus. The blockchain 2000 uses a consensus mechanism, such as proof of work (PoW) or proof of stake (POS), to ensure agreement among participants on the validity of transactions. In a transaction, either the sender or receiver sends a communication to the system. This can be done through a wallet application or a trading platform that supports the specific blockchain 2000. The initiating party creates a digital transaction specifying details such as the recipient's address, the amount of assets to be transferred, and any additional data required by the blockchain. In some embodiments, the smart contract requires the token holder to provide a unique identifier, such as a wallet address, associated with the tokens to help establish ownership. The transaction is broadcast to the blockchain network for validation. Once validated, the transaction is bundled with other validated transactions to form a block. This block is added to the blockchain's ledger.

In one embodiment, token holders can initiate redemption requests, executed through the smart contracts, leading to the burning of tokens upon successful redemption. When a redemption request is received by the system, a process is initiated to transfer the physical asset from the custodian to the owner of a cryptocurrency token initiating the redemption request. In one embodiment, the smart contract outlines terms for redeeming tokens for the physical asset, including the number of tokens required for redemption and the process for arranging delivery of the physical asset.

In some embodiments, upon processing of the redemption request, the system initiates a burn that reduces the total number of tokens in relation to the size of the redemption. In this way, the total number of tokens corresponds with the amount of physical asset and the token does not become diluted. Similar to a transaction request, the redemption request needs to be recorded and validated. The redemption is broadcast to the blockchain network for validation. Once validated, the transaction is bundled with other validated transactions to form a block. This block is added to the blockchain's ledger.

When new physical assets are added or newly introduced, the system provides for the issuing of new tokens, wherein a specific number of tokens represents a first amount of the physical asset. In this way, the system maintains a set ration of tokens to physical assets so as to not deflate the token value and expand the available tokens. Newly created tokens are backed by the asset per token amount that is currently established.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for administering a specialized trading network of a physical asset via a cryptocurrency on a blockchain, the system comprising:
a cryptocurrency token linked with the physical asset;
wherein the physical asset is disposed within a secure location;
wherein a physical asset reserve amount which represents the total physical asset is updated in real-time on the blockchain;
the specialized trading network comprising a plurality of computers, wherein the specialized trading network includes the blockchain having decentralized ledger that records the quantity and ownership of the cryptocurrency token;
a trading protocol configured to establish trade communications, exchange, and redemption on the specialized trading network;
wherein the trading protocol maintains a calculation of physical asset per cryptocurrency token based on the physical asset reserve amount.

2. The system of claim 1, wherein the trading protocol is configured to redeem the cryptocurrency token for the underlying physical asset.

3. The system of claim 2, wherein the trading protocol is configured to execute a smart contract to facilitate the cryptocurrency token to physical asset exchange.

4. The system of claim 1, wherein the specialized trading network comprises:
a processor;
a memory communicatively coupled to the processor, the memory storing computer readable instructions that when executed by the processor causes the processor to:
receive a transaction request for a transfer of the cryptocurrency token from a sender to a recipient;
wherein the transaction request includes the recipient's address and an amount of cryptocurrency tokens to be transferred.

5. The system of claim 4, wherein the processor is configured to:
record and validate the transfer by broadcasting the transaction request to the specialized trading network for consensus.

6. The system of claim 5, wherein the processor is configured to:
publish the validated transaction to the blockchain for public visibility.

7. The system of claim 6, wherein the processor is configured to:
receive a redemption request for a transfer of the physical asset from an owner of a cryptocurrency token;
wherein the redemption request is configured to execute the smart contract.

8. The system of claim 7, wherein the smart contract outlines terms for redeeming tokens for the physical asset, including the number of tokens required for redemption and the process for arranging delivery of the physical asset.

9. The system of claim 8, wherein the processor is configured to:
burn the tokens associated with the redemption, thereby reducing the total number of tokens.

10. The system of claim 9, wherein the processor is configured to:
record the burn to the blockchain.

11. The system of claim 4, wherein the processor is configured to:
issue new cryptocurrency tokens on the blockchain, wherein a specific number of tokens represents a first amount of the physical asset.

12. A method for administering a specialized trading network of a physical asset via a cryptocurrency on a blockchain, the method comprising:
issuing a cryptocurrency token linked with the physical asset on a blockchain, wherein the physical asset is disposed within a secure location;
wherein a physical asset reserve amount which represents the total physical asset is updated in real-time on the blockchain;
providing the specialized trading network comprising a plurality of computers, wherein the specialized trading network includes the blockchain having decentralized ledger that records the quantity and ownership of the cryptocurrency token;
establishing a trading protocol configured to establish trade communications, exchange, and redemption on the specialized trading network;
wherein the trading protocol maintains a calculation of physical asset per cryptocurrency token value based on the physical asset reserve amount.

13. The method of claim 12, further comprising:
receiving a transaction request for a transfer of the cryptocurrency token from a sender to a recipient;
wherein the transaction request includes the recipient's address and an amount of cryptocurrency tokens to be transferred.

14. The method of claim 13, further comprising:
recording and validating the transfer by broadcasting the transaction request to the specialized trading network for consensus.

15. The method of claim 14, further comprising:
publishing the validated transaction to the blockchain for public visibility.

16. The method of claim 15, further comprising:
receiving a redemption request for a transfer of the physical asset from an owner of a cryptocurrency token;
wherein the redemption request is configured to execute the smart contract.

17. The method of claim 16, wherein the smart contract outlines terms for redeeming tokens for the physical asset, including the number of tokens required for redemption and the process for arranging delivery of the physical asset.

18. The method of claim 16, further comprising:
burning the tokens associated with the redemption, thereby reducing the total number of tokens.

19. The method of claim 18, further comprising:
recording the burning of the tokens associated with the redemption to the blockchain.
